(19) United States
(12) Patent Application Publication
(10) Pub. No.: US 2014/0153864 A1
(43) Pub. Date: Jun. 5, 2014

(54) LOW COST EXTENDED DEPTH OF FIELD OPTICAL PROBES

(71) Applicant: NinePoint Medical, Inc., Cambridge, MA (US)

(72) Inventors: Matthew A. Sinclair, Somerville, MA (US); Narissa Y. Chang, Somerville, MA (US)

(73) Assignee: NinePoint Medical, Inc., Cambridge, MA (US)

(21) Appl. No.: 14/090,356

(22) Filed: Nov. 26, 2013

Related U.S. Application Data
(60) Provisional application No. 61/733,056, filed on Dec. 4, 2012.

(51) Int. Cl. G02B 6/26

(52) U.S. Cl. CPC G02B 6/26
USPC 385/12

(57) ABSTRACT

An extended depth of field optical probe includes a lens; and a spacer positioned adjacent the lens, the spacer and lens are configured to produce a plurality of waists at a plurality of working distances by varying at least one of an index of refraction of adjacent optical components of the spacer and a physical geometry of a surface of the probe, and the working distance of a first waist is greater than 0.

### TECHNICAL FIELD

The present disclosure generally relates to medical devices, systems and methods for imaging in biomedical and other medical and non-medical applications, and more particularly, to optical probes for Optical Coherence Tomography (OCT) imaging.

### BACKGROUND

Various forms of imaging systems are used in healthcare to produce images of a patient. Often, an image of an internal cavity of a patient is required. These cavities can include areas of the digestive system or the respiratory system. When imaging tissue features of these systems, fiber optic endoscopy is often utilized.

One type of fiber optic endoscope is based on Optical Coherence Tomography (OCT) techniques. OCT provides structural information on tissue with high resolution. OCT can provide this information in real time and in a non-invasive manner. Many different lens types have been used to construct fiber optic endoscopes. These lenses include fiber lenses, ball lenses and GRadient INdex (GRIN) lenses. Lens materials can vary from glass to plastic to silicon.

As shown in FIGS. 1A and 1B, one type of OCT probe 10 for a fiber optic endoscope includes an optical fiber 11 having a cladding 11a, a fiber core 11b, a proximal end 12 and a distal end 13. A ferrule 7 is included to hold optical fiber 11 in place. Probe 10 also includes a spacer 16 connected to distal end 13 of optical fiber 11, a GRIN lens 14 connected to spacer 16, and a prism 15 connected to GRIN lens 14 and configured to deflect light into surrounding tissue T. Although an optional component, spacer 16 is included and positioned before GRIN lens 14 to modify the optical parameters. The separate components, i.e. fiber core 11b, spacer 16, GRIN lens 14, and prism 15, are typically connected by fusing the components together or using an epoxy to glue the components together. In total, this design requires 8 distinct and separate surfaces that light must travel through or reflect off in a probe of this design.

Ferrule 7 can be made out of glass (e.g., Borosilicate glass). The type of glass is not important because ferrule 7 is a structural member and not an optical member. Ferrule 7 is also hollow to encapsulate optical fiber 11. Ferrule 7 can be attached to probe 10 by exposing ferrule 7 to ultra-violet UV radiation to make ferrule 7 tacky and then exposing ferrule 7 and probe 10 to thermal radiation to bond them together. Alternatively, ferrule 7 may be bonded to probe 10 by UV radiation or thermal radiation alone. Ferrule 7 may also be glued to probe 10. In another alternative embodiment, ferrule 7 is fused to probe 10 using electrode filaments. Additionally, a ferrule end 19, not in contact with spacer 16, is polished to be made flat.

Probe 10 is typically connected to a source for coherent light L at proximal end 12 of optical fiber 11. Probe 10 is typically contained within a sheath S (e.g. a lumen) and a balloon B. Alternatively, probe 10 can be manufactured without sheath S and balloon B, or be within sheath S without balloon B. Sheath S containing probe 10 is inserted into a cavity of a patient to image into tissue T surrounding probe 10. Sheath S protects probe 10 and tissue T from damage and provides for air separation, patient protection, and centering.

FIG. 1B is a diagram illustrating an imaging system for use with probe 10. Probe 10 is typically connected to a coherent light source 19 at proximal end 12 of optical fiber 11 through a rotary junction 18 and optical components 17. Also included is a detector 20 to detect light reflected back from tissue T. The optical components 17 can include elements to direct light from light source 19 toward probe 10 and elements to direct light from probe 10 to detector 20.

System 1 is shown connected to specialized computer 30. Specialized computer 30 provides control for the components of system 1. Specialized computer 30 also provides image processing functions to produce images from light detected at detector 20. Specialized computer 30 can include one or more input devices such as a keyboard and/or a mouse (not shown). Specialized computer 30 can also include one or more output devices such as a display (not shown) for displaying, for example, instructions and/or images.

In operation, and also with reference to FIG. 2, light L travels from light source 19, through optical components 17, rotary junction 18, optical fiber 11, spacer 16, lens 14 and prism 15 and into tissue T. Light L is reflected back from tissue T, through prism 15, lens 14, spacer 16 and optical fiber 11, and is directed by optical components 17 to detector 20.

In order to provide an image of a particular area of tissue T, probe 10 is translated along and rotated about axis Z. This translation and rotation directs light L into tissue T at an area of concern. In order to produce a complete radial scan of tissue T surrounding probe 10, probe 10 must be rotated 360 degrees to produce an image of a first slice of tissue T and then translated along direction X to produce an image of an adjacent slice of tissue T. This rotation/translation process continues along direction X until the area of concern of tissue T is completely scanned.

An optical probe must be specifically manufactured to conform to optical parameters required for a specific use. Esophageal imaging, for example, requires probes of specific design to properly image into surrounding tissue. Typical prior art probes do not provide the specific optical operating parameters required in esophageal imaging.

This disclosure describes improvements over these prior art technologies.

### SUMMARY

Accordingly, a low cost extended depth of field optical probe is provided. The extended depth of field optical probe includes a lens; and a spacer positioned adjacent the lens, wherein the spacer and lens are configured to produce a plurality of waists at a plurality of working distances by varying at least one of an index of refraction of adjacent optical components of the spacer and a physical geometry of a surface of the probe, and wherein the working distance of a first waist is greater than 0.

Accordingly, a low cost extended depth of field optical probe is provided. The low cost extended depth of field optical probe includes a mounting portion to mount an optical fiber; a beam expander positioned in a path of an optical beam of the optical probe configured to expand the optical beam; and a lens positioned in the path of the optical beam of the optical probe configured to focus the optical beam, wherein the beam expander is configured to change an optical path length at different portions of the optical beam producing a plurality of waists at a plurality of working distances, and wherein the working distance of a first waist is greater than 0.

Accordingly a method for generating multiple waists and an extended depth of field by an optical probe is provided. The method for generating multiple waists and an extended depth of field by an optical probe, includes modifying at least one portion of a light traveling along a light path to change an optical path length of the modified portion of light and produce a plurality of waists at a plurality of working distances, wherein the working distance of a first waist is greater than 0.

### BRIEF DESCRIPTION OF THE DRAWINGS

The present disclosure will become more readily apparent from the specific description accompanied by the following drawings, in which:

FIG. 1 is a diagram illustrating a conventional optical probe;

FIG. 1B is a diagram illustrating an imaging system for use with the present disclosure;

FIG. 2 is a diagram illustrating various operating parameters of an optical probe;

FIG. 3A is a diagram illustrating a first design of an optical probe according to the present disclosure;

FIG. 3B is a diagram illustrating an expanded view of the spacer of FIG. 3A;

FIG. 3C is a diagram illustrating a cross-sectional view of the spacer of FIG. 3A;

FIG. 4A are diagrams illustrating a second design of an optical probe according to the present disclosure;

FIG. 4B is a diagram illustrating another design of an optical probe according to the present disclosure;

FIG. 5 is a diagram illustrating another second design of an optical probe according to the present disclosure;

FIG. 6 is a diagram illustrating a third design of an optical probe according to the present disclosure;

FIG. 7 is a diagram illustrating a fourth design of an optical probe according to the present disclosure;

FIG. 8 is a diagram illustrating a fifth design of an optical probe according to the present disclosure;

FIGS. 9-14 are Tables 1-6 illustrating varying design data and parameters for the optical probe of Design 1;

FIGS. 16-20 are Tables 7-12 illustrating varying design data and parameters for the optical probe of Design 2; and

FIGS. 21-22 are Tables 13-14 illustrating varying design data and parameters for the optical probe of Design 3.

Like reference numerals indicate similar parts throughout the figures.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

Reference will now be made in detail to the exemplary embodiments of the present disclosure, which are illustrated in the accompanying figures.

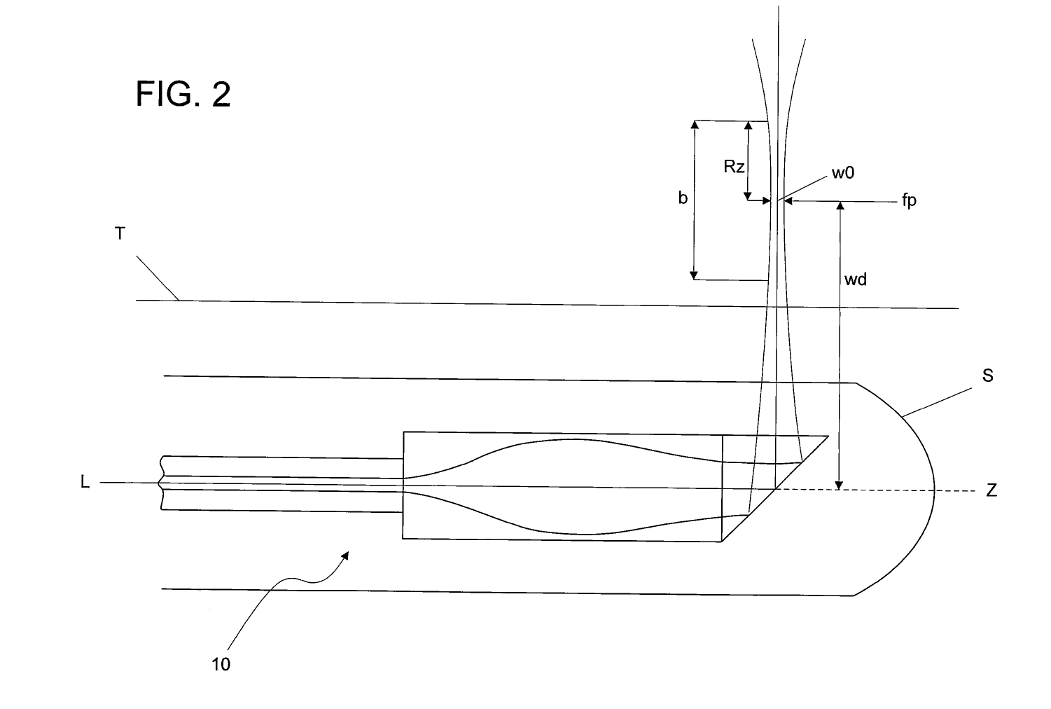

Referring to FIG. 2, proper imaging into tissue using an Optical Coherence Tomography (OCT) probe requires strict compliance to probe specifications in order to precisely set the optical parameters. These parameters can include the Rayleigh Range Rz, the confocal parameter b, the waist w0, the focal point fp, and the working distance wd. The term “beam waist” or “waist” as used herein refers to a location along a beam where the beam radius is a local minimum and where the wavefront of the beam is planar over a substantial length (i.e., a confocal parameter length). For purposes of this disclosure, the term “working distance” (wd) means the distance from the focal point to the mechanical axis of rotation Z of the probe.

An optical probe must be specifically manufactured to conform to the optical parameters required for a specific procedure and application. Esophageal imaging requires probes of specific design to properly image into surrounding tissue T. Generally in esophageal imaging the working distances from the center of the optical probe radially outward to the tissue ranges from about 7 millimeters (mm) to about 12.5 mm. The optic itself can be about 0.5-5.0 mm in diameter, with a protective cover (not shown) in sheath S, and with balloon B on top, while still fitting through a channel measuring about 1.2-4.2 mm in an endoscope. With no tight turns required during the imaging of the esophagus (compared, for example, to the biliary system, digestive system or circulatory system), an optical probe rigid length can be as long as about 14 mm in length without interfering with surrounding tissue T.

Generally in esophageal imaging there is about a 6-12 mm distance between the outer surface of sheath S and surface of tissue T in contact with balloon B. When using an optical probe for esophageal imaging, a long working distance wd with large confocal parameter b is required. Increasing the confocal parameter b while remaining within the design specifications of a probe can greatly increase the versatility of a probe. By increasing the confocal parameter b, the optical probe can extend the imaging depth at any single pass of the probe. In prior attempts, because the manufacturing tolerances are extremely tight, they do not allow for the production of an optical probe that is simple to manufacture and conforms to the optical parameters required in esophageal imaging while increasing the confocal parameter.

Achieving an increase in the confocal parameter greatly increases the versatility of the OCT probe in that a greater tissue image can be achieved. In attempts to manufacture optical probes that conform to the parameters and exhibit the desired increase in the confocal parameter, several designs have been utilized.

One design utilizes a phase mask GRadient INdex (GRIN) lens that is produced from GRIN lens material. The smaller GRIN lens, which behaves as a phase mask, is positioned after a first GRIN lens of an OCT probe. The phase mask GRIN lens has a smaller core diameter than the core of the first GRIN lens. This design produces a double focus lens, that is, a lens producing 2 separate and distinct waists. Although this design can produce positive results, it is extremely difficult to manufacture since the length of the first GRIN lens must be approximately 1 mm and the length of the phase mask GRIN lens must be about 100-250 μm. The tolerances are also quite exacting, being in the range of only about 1-2 μm. To achieve such tolerances, polishing is performed on the lenses with active monitoring, which may break the GRIN lens off. Cleaving can also be used, but is typically accurate only to about 25 μm, and at best about 5 μm.

In another attempt to extend the field of depth, software algorithm intensive systems are employed. As discussed above, the tight tolerances often produce defects in the optics of the probe. One method to correct for these defects is to repetitively image a target image in order to measure the defects of an optic. Software algorithms can then be utilized to adjust for the defects, but many problems exist. For example, each probe contains a phase mask which needs to be very well characterized per probe and then loaded into the software. This process is extremely time consuming, dependent on a probe to probe basis, and can result in power losses in the ranges of greater than 90%. The algorithms essentially utilize spherical aberration as a means of extending depth of focus and often the center of the probe is blocked only letting the rays on the edge propagate forward. This limits any increase in the depth of focus and blocks most of the power that should be used for image generation. Attempts to correct for this loss of power include increasing laser power, which comes with a dangerous increase of safety issues, e.g. probe meltdown. The spherical aberration is dependent on the field, i.e. the aberration increases as the depth of field increases.

The second key method for using algorithms to sharpen an image and increase depth of field is to estimate the aberrations in the optical system and the tissue. As with any rough estimation, this process can often be deceiving since it creates a sharper image that is not real by removing aberrations from an image until it is “sharper.” The “sharpness” obtained is relative and the process difficult when the exact shape and size of the imaging target is unknown, which is almost always the case in medical imaging. In addition, the algorithm process slows down the processing to a point where the system can no longer produce a live image.

Another design utilizes an axicon lens. The conical surface of the axicon lens produces a Bessel beam from a Gaussian beam by producing a series of multiple waists that create an almost “continuous waist”. These axicon lens designs have the surfacing image (e.g. tissue) almost in contact with the optics, but still have an air gap between the surfacing image and the optics making axicon lens designs ideal for surface imaging since the waist is just off the tip of the axicon lens itself. This unfortunately produces a working distance that approaches zero (0) for the distance of the first waist. The first waist is important since it determines the beginning of the depth of focus. A single axicon lens could not be used for esophageal imaging since the working distance is zero for the first waist, which wastes valuable imaging power between the lens and the imaging target. For example, a 33 um 1/ê2 radius beam waist with a Rayleigh range of 2.7 mm, the depth of focus would only be 2.7 mm from the axicon. In esophageal imaging it is preferred to have the 33 um 1/ê2 radius beam waist located 2.7 mm from the axicon to generate a depth of focus of 5.4 mm, where the depth of focus is equal to the distance between the first and last confocal parameter edges.

For example, if the optical is power divided into two separate waists that do not have overlapping confocal parameters, the loss in signal would be −3 dB since the power is 50% less, and three separate waist without overlapping confocal parameters would have a signal loss of −4.8 dB (33% of power in each waist). A typical console has a 110 dB sensitivity, therefore a −3 dB change in signal would decrease the sensitivity to 107 dB (above 90 dB is considered clinically relevant for tissue). An axicon creates a Bessel beam (series of waist) immediately starting at the apex of the axicon and throws away a significant amount of signal and resolution by creating a depth of field that lands heavily on the optical probe itself. Therefore, there is a considerable amount of Rayleigh range that cannot be used. In order to move the waist from the tip using an axicon lens, the conical shape required would pull the tip inches from the base, creating an overall length that is well outside the working parameters of an OCT probe. The zero (0) mm working distance makes the design useless for esophageal imaging.

Another axicon lens based probe utilizes several axicon lenses strung out in series to move the working distance outward from the tip of the typical axicon lens system. These multi-axicon systems require each axicon lens be free from even minor defects and exactly spaced to operate as desired. The design is meant for optics with outer diameters greater than about 3 mm. The tolerance of aligning 3 axicons with about a 1 mm diameter renders the design useless and non-manufacturable in large quantities.

These prior art optical probes are often difficult to produce in volume, have short working distances, and/or are only plausible for optics with diameters greater than about 3 mm.

The present disclosure provides extended depth of field optical probes exhibiting the following advantages over the prior art: long working distance, variable confocal parameter (tradeoff between peak intensity and length of confocal parameter), relatively easy to manufacture in high volumes, increased area of imaging, and small in overall size.

Achieving an increase in the confocal parameter greatly increases the versatility of the OCT probe in that deeper tissue imaging can be achieved having a greater depth of field. It is also possible to use one probe for multiple balloon sizes. The confocal parameter b determines the imaging depth and is inversely related to the transverse resolution. With a larger waist w0 size, the confocal parameter b increases while the transverse resolution decreases. Or in other terms, as the waist w0 increases the Raleigh range Rz also increases. The disclosure proposes apparatus, systems and methods to maintain the transverse resolution, by maintaining spot size, to an acceptable level while increasing the area of the confocal parameter b of the optical probe by having multiple waists at different locations.

The present disclosure relates to extended depth of field optical probes for an OCT system that allow for a greater area to be imaged with high Signal-to-Noise Ratio (SNR) and resolution. The present disclosure teaches optical probes that conform to the specific requirements of esophageal imaging while increasing the confocal parameter and extending the depth of field. In particular, the optical probes described herein are low cost extended depth of field optical probes.

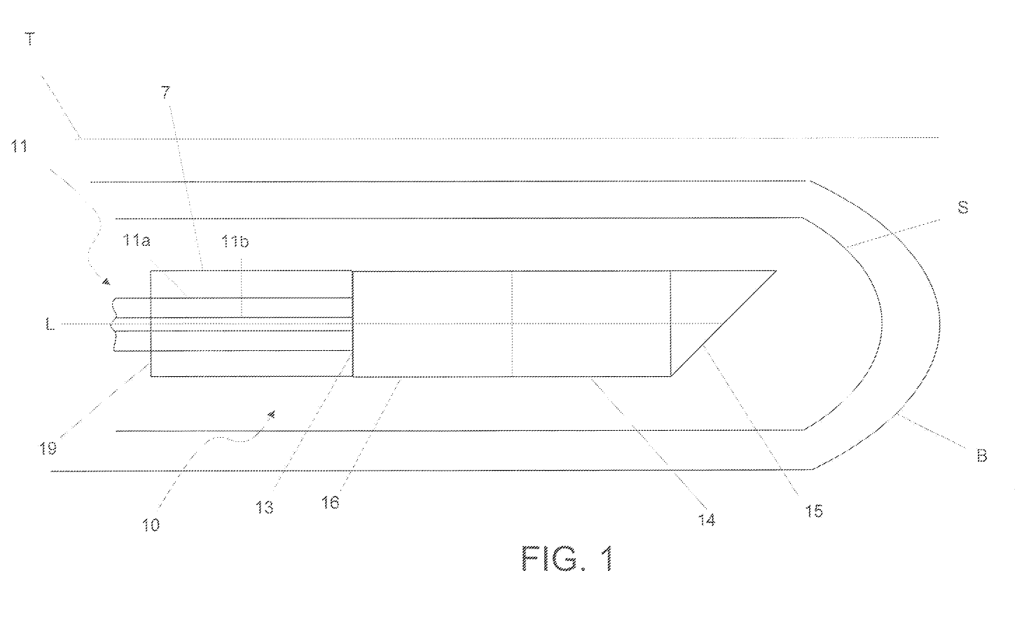

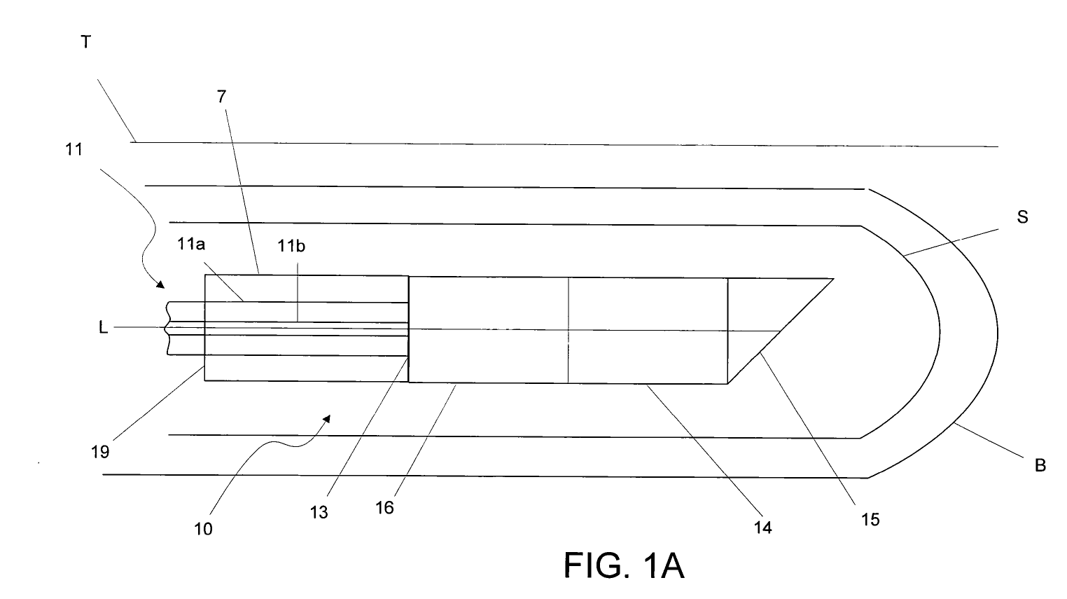

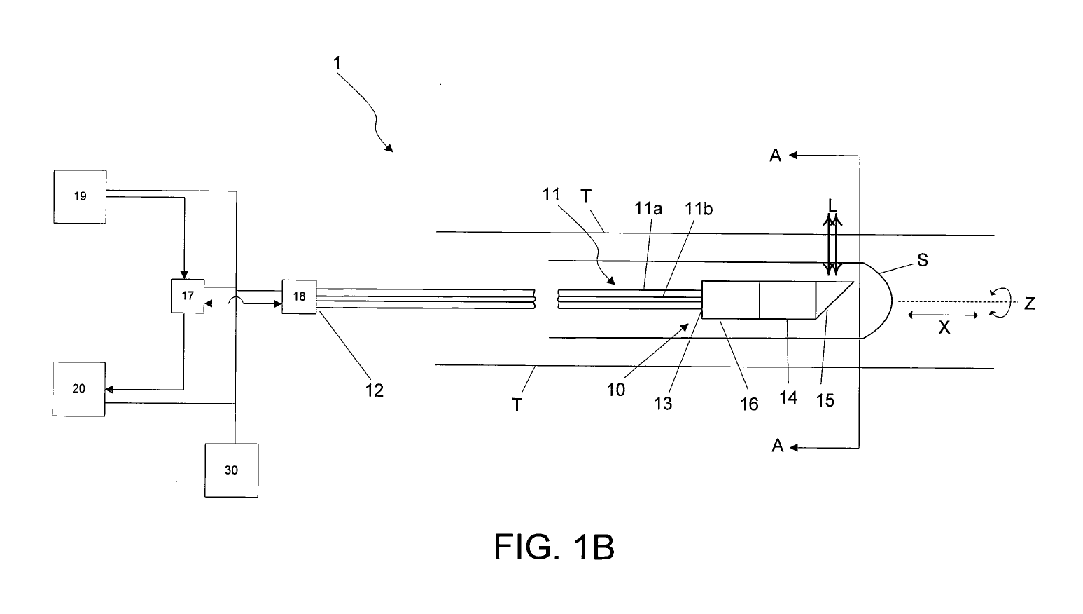

It is noted that all of the optical probes described herein are connectable to an image processing system, for example as illustrated in FIG. 1B, for signal processing and/or display purposes.

Design 1

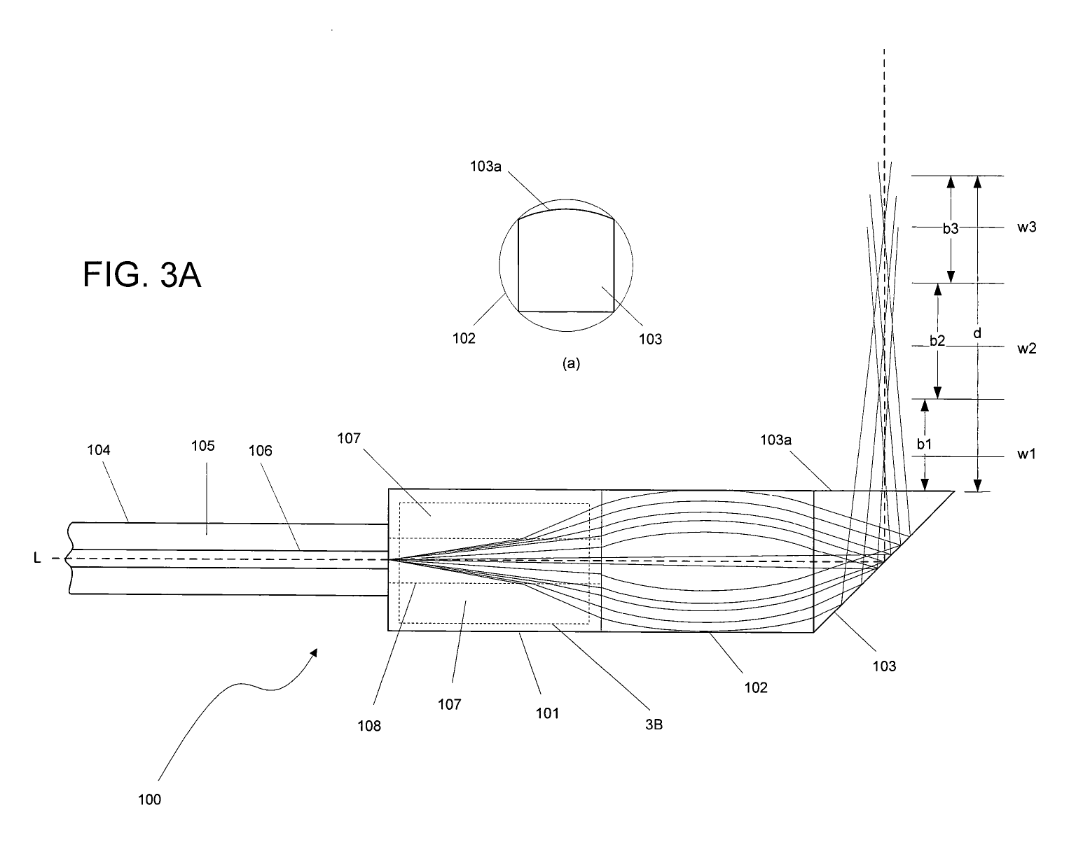

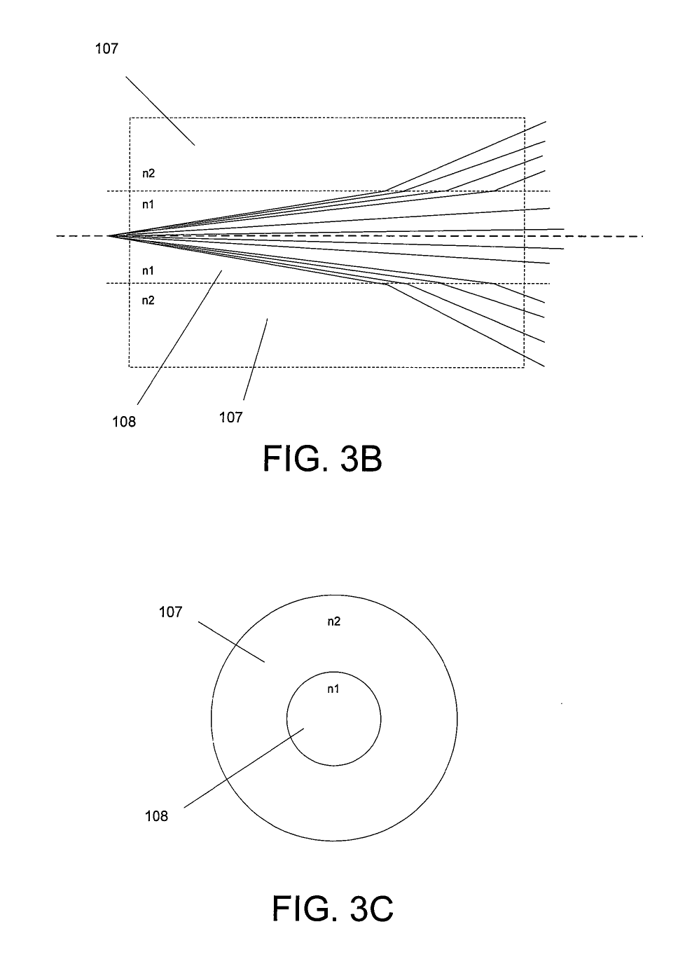

A first design of a low cost extended depth of field optical probe 100 is illustrated in FIG. 3A. Shown are single mode fiber 104, spacer 101, lens 102 and prism 103. Since the optical probe illustrated in FIG. 3A is described in connection with an OCT system for esophageal imaging, prism 103 is included herein; other configurations are contemplated for use without a prism. Exposed face 103a of prism 103 includes a cylindrical radius of curvature and is shown in more detail in diagram (a), which is an end view of the probe from the prism. The curvature is convex and follows the direction of the inner lumen (i.e. sheath S), which is used to remove the negative power added by the inner lumen. The cylindrical power can be perpendicular to the direction shown with a concave shape instead of convex, which can add negative power to match the power added by the inner lumen. Both methods create a probe with the same back focal length. Since the same back focal length is not always desired for the x and y axis, these methods may be used to control the each independently. The cylindrical radius of curvature is needed to correct for the power added by the sheath S. The radius of curvature ranges greatly from about 2.5 mm to about 10 mm for esophageal imaging, but may as small as 0.23 mm radius of curvature on very small probes. The cylindrical radius of curvature is dependent on the inner diameter, outer diameter, and material choice of the inner lumen, i.e. sheath. Typically, lens 102 is a GRIN lens. Single mode fiber 104 includes a cladding 105 and a core 106. Spacer 101 includes an outer portion 107 and an inner core 108. A ferrule is not shown in FIG. 3A but can be employed.

FIG. 3B is an expanded view of section 3B of the spacer of FIG. 3A and FIG. 3C is a cross-sectional view of the spacer of FIG. 3A. The diameter of inner core 108 inside of outer portion 107 can be modified to adjust how and where the power is focused, i.e. create a proper beam waist and position. Spacer 101 is illustrated as a 2 layer construction (inner core 108 and outer portion 107), but may have multiple sections with varying indices of refraction to control scattering and power handling, as well as adding additional beam waists. As increase in the number of layers towards infinity would produce a GRIN-type lens. The maximum number of layers significantly depends on the probe size, waist size, and waist location. By changing the index of refraction n of the outer portion 107 and the core 108 of the spacer 101 (n2 and n1, respectively), the depth of field d can be changed by modifying the optical path length. This produces images that appear at different locations. In theory, these effects are similar to the Doppler effect in that relative distance matters. As shown in FIG. 3B, the angle of the light rays change when hitting a new index of refraction, for example, when light travels from index of refraction n1 to index of refraction n2.

In one design, when the index of refraction n2 of the outer portion 107 is greater than the index of refraction n1 of the core 108, the optical probe 100 causes the received light L to refract and travel at different rates when traveling through the spacer 101. This gives different optical path lengths in relation to the optical field. The multiple indexes of refraction create different waists w1-w3. The probe by this design also avoids total internal reflection preventing any light from reflecting back towards the light source. GRIN lens 102 focuses the expanded light and prism 103 reflects the expanded light to the side of the probe 100. Each component of the expanded light defines its own waist w1-w3 and respective confocal parameter b1-b3, but the total depth of field d is extended to encompass all confocal parameters b1-b3. Some or all of the images resulting from the multiple waists can then be combined via known signal processing algorithms in specialized computer 30.

Changing the indexes of refraction of the core 108 and the outer portion 107 will in turn change the way the light L is focused without the need to modify the lens 102. The multiple waists w1-w3 can form a continuous stream of waists as illustrated. Also, waist(s) (e.g. w1) can be positioned in an unaligned manner by modifying the index(es) of refraction. The distances at which the waist(s) are formed from the surface of the exposed side 103a of the prism can also be changed by modifying the index(es) of refraction. Thus, location, size and number of waists can be easily controlled by controlling the optical path lengths for each waist via the disclosed probes. A lens having a focal length of 500 mm can produce an effective focal length of approximately ½ meter.

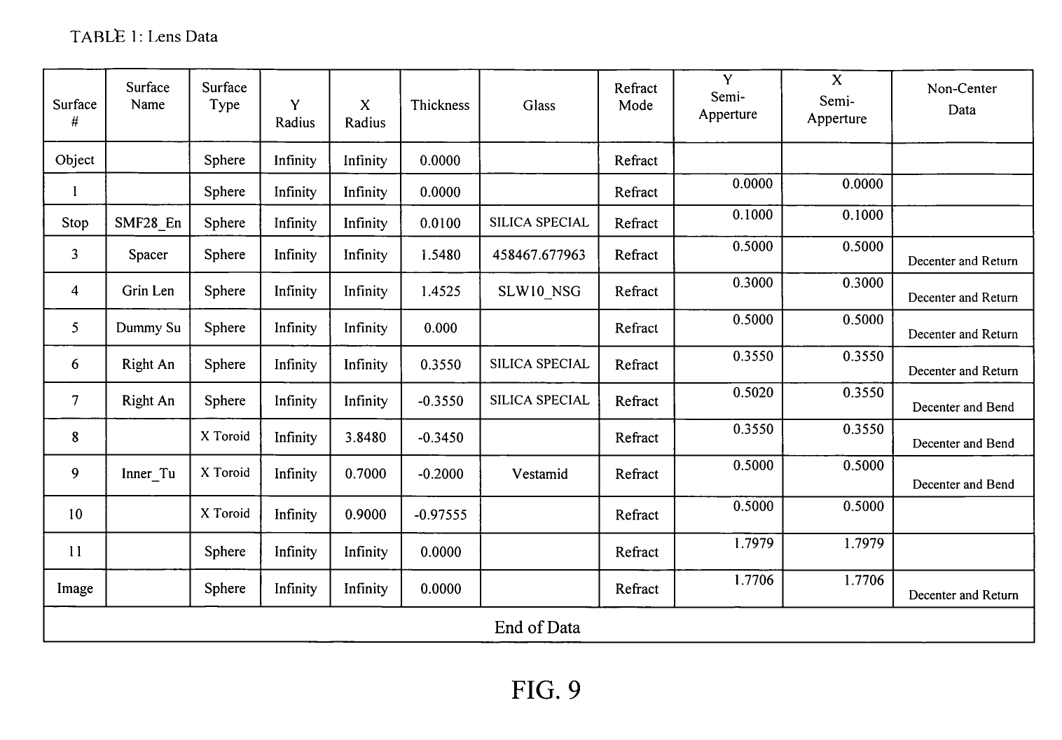

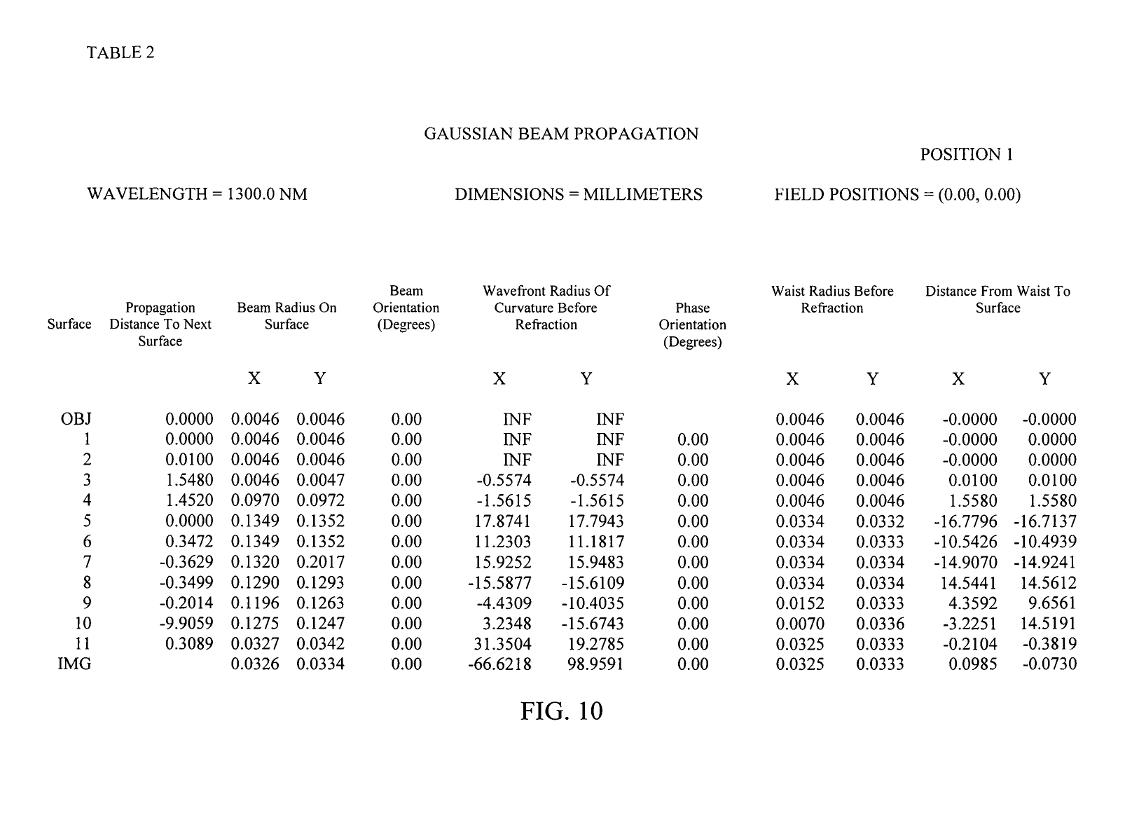

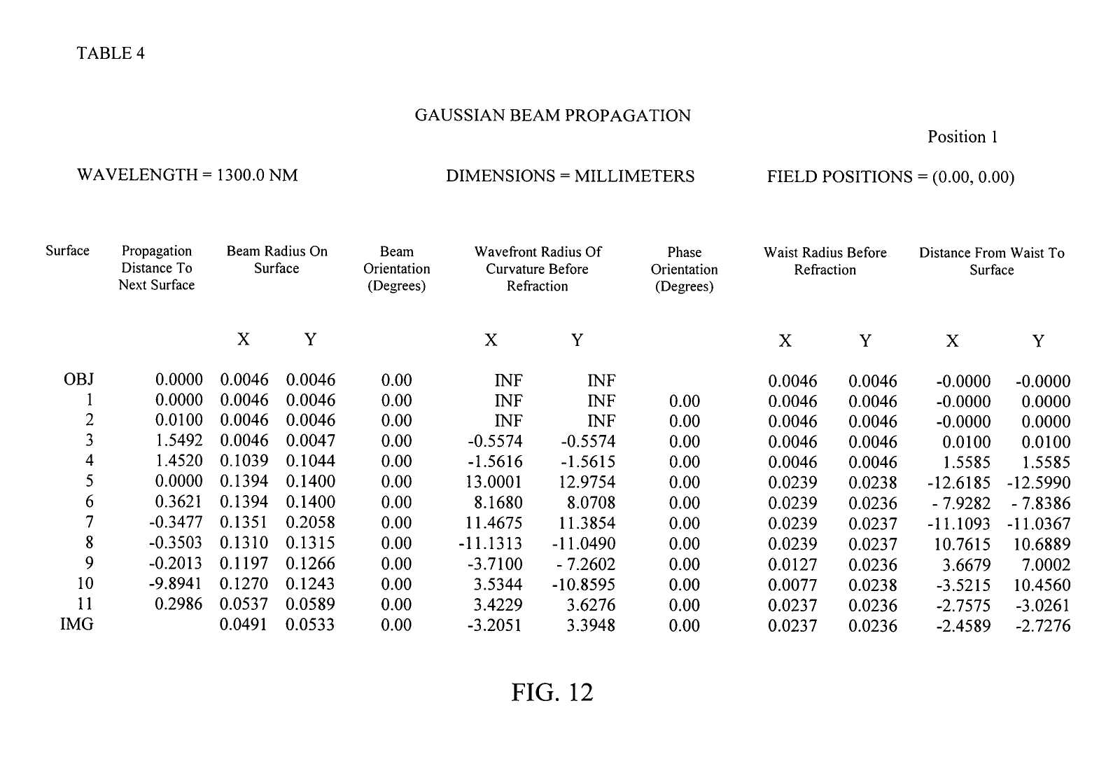

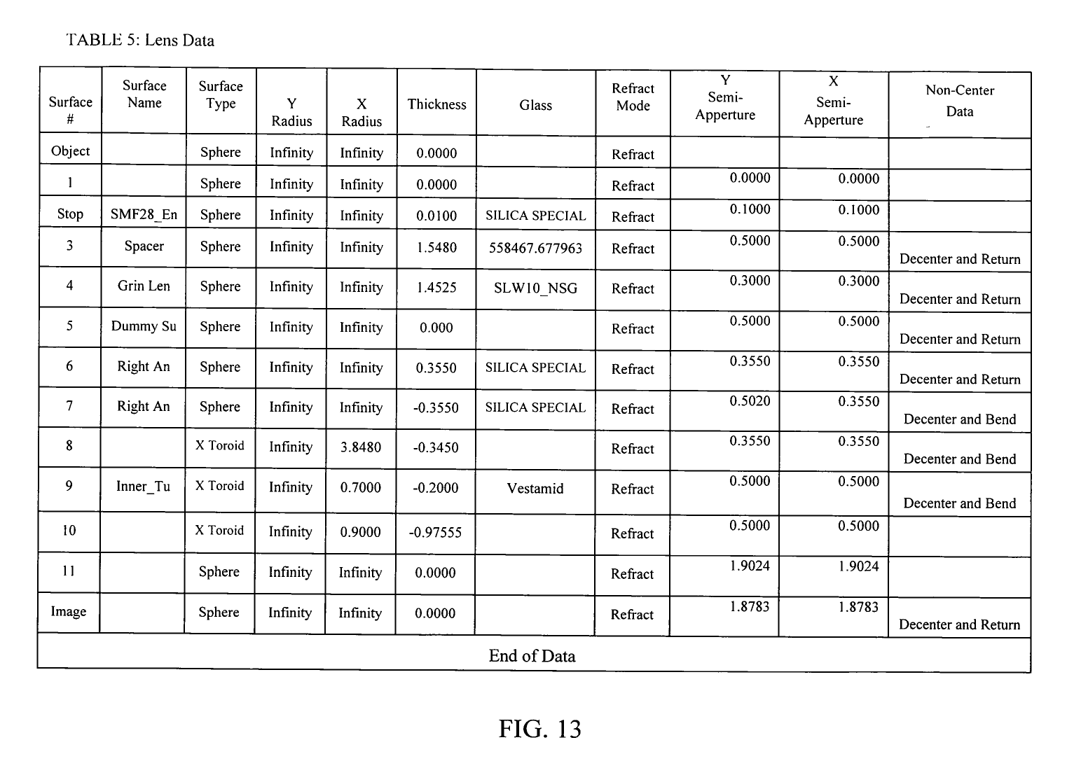

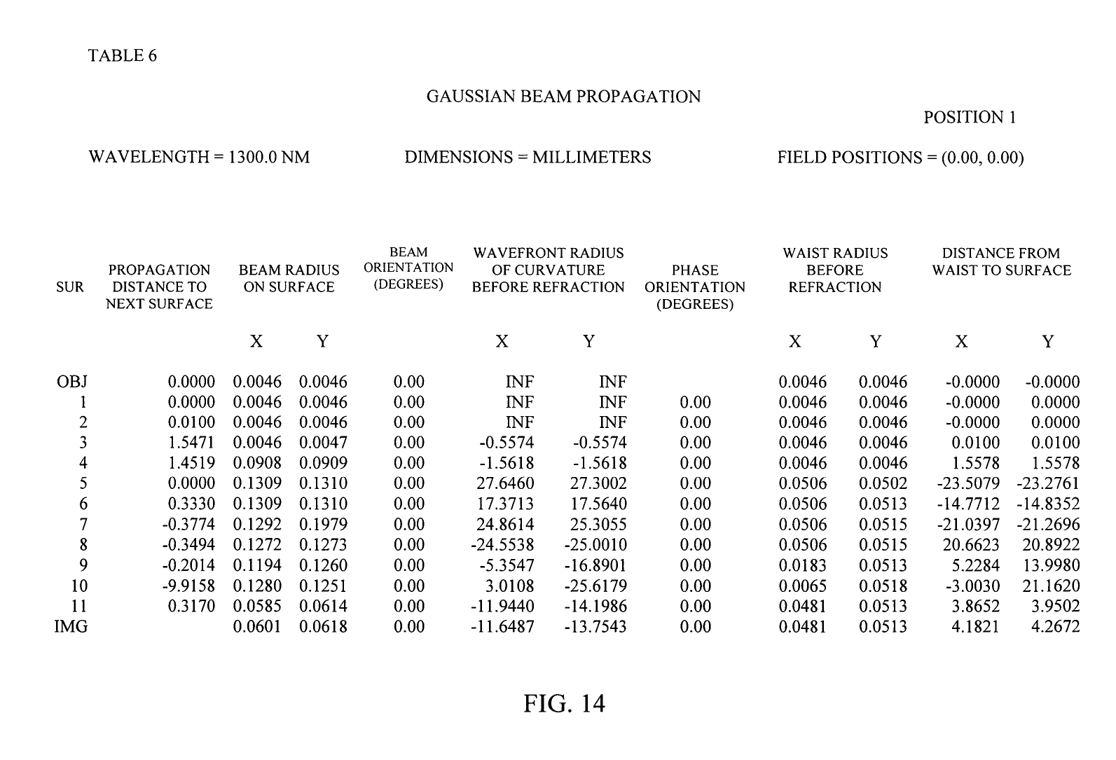

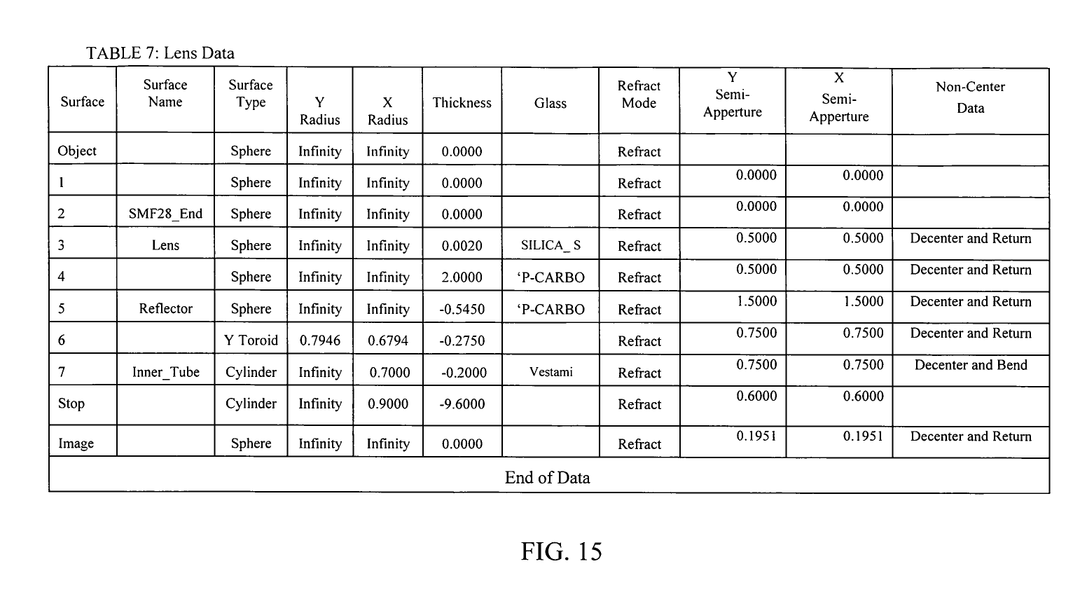

Tables 1-6 submitted as FIGS. 9-14 illustrate varying design data and parameters for the optical probe of Design 1. The experimental data shown in Tables 1-6 utilized a 1.4525 mm GRIN lens and a spacer formed from glass. In Tables 1-2 a glass of glass code 458467.677963 was used. A glass code in this form implies a leading 1 in front of the first part of the number, i.e. 458467, therefore, the index of refraction is 1.458467 (typically stated for n_d (index of refraction at red/589 nm). The second number is the abbe number, which describes the amount of dispersion the glass has and a decimal after the first two digits is implied. This glass has an abbe number of 67.7963.

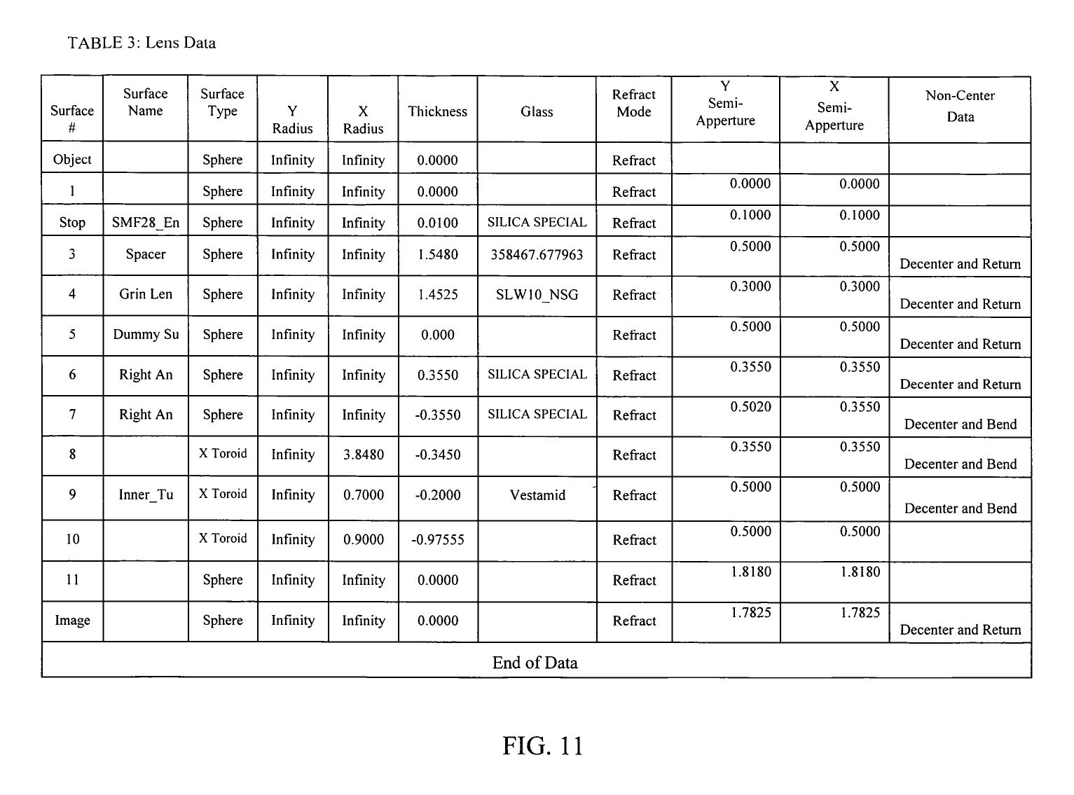

In FIG. 11 the glass code is 358467.677963, which is a 0.10 index of refraction change in the glass that shifts the waist about 2.5 mm. The probe can be designed such that the glass is on either the outside or inside. In a preferred embodiment, the material with the lower index of refraction is positioned on the inside, which assists in preventing total internal reflection TIR from occurring. This design is an inverse of a fiber optic cable since the light is not being coupled back into the “core” glass, but rather “pulled” out with minimal interference.

The experimental data of Tables 3-4 demonstrates the effects that a change of −0.10 in the index of refraction has on the beam radius and working distance. The experimental data of Tables 3-4 demonstrates the effects that a change of +0.10 in the index of refraction has on the beam radius and working distance. The change in the waist size is shown having a 1/ê2 mm radius. As is illustrated by the experimental data, the working distances and the positions of the waists can be adjusted by adjusting the indexes of refraction.

Design 2

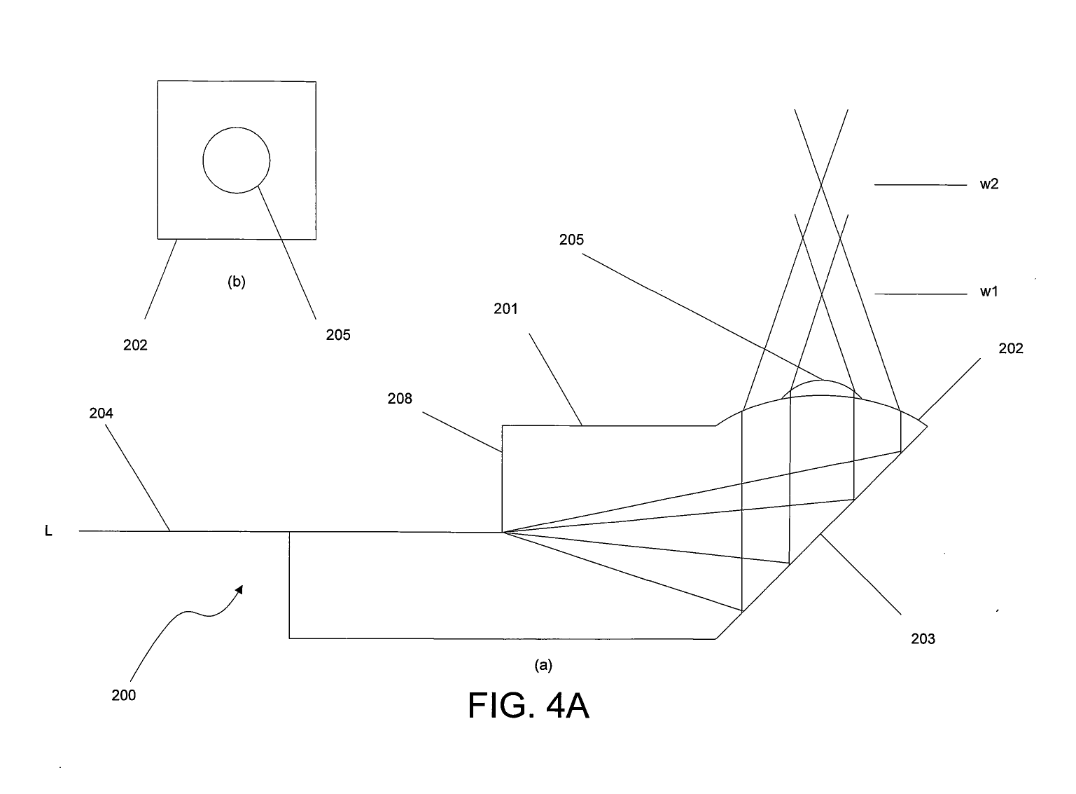

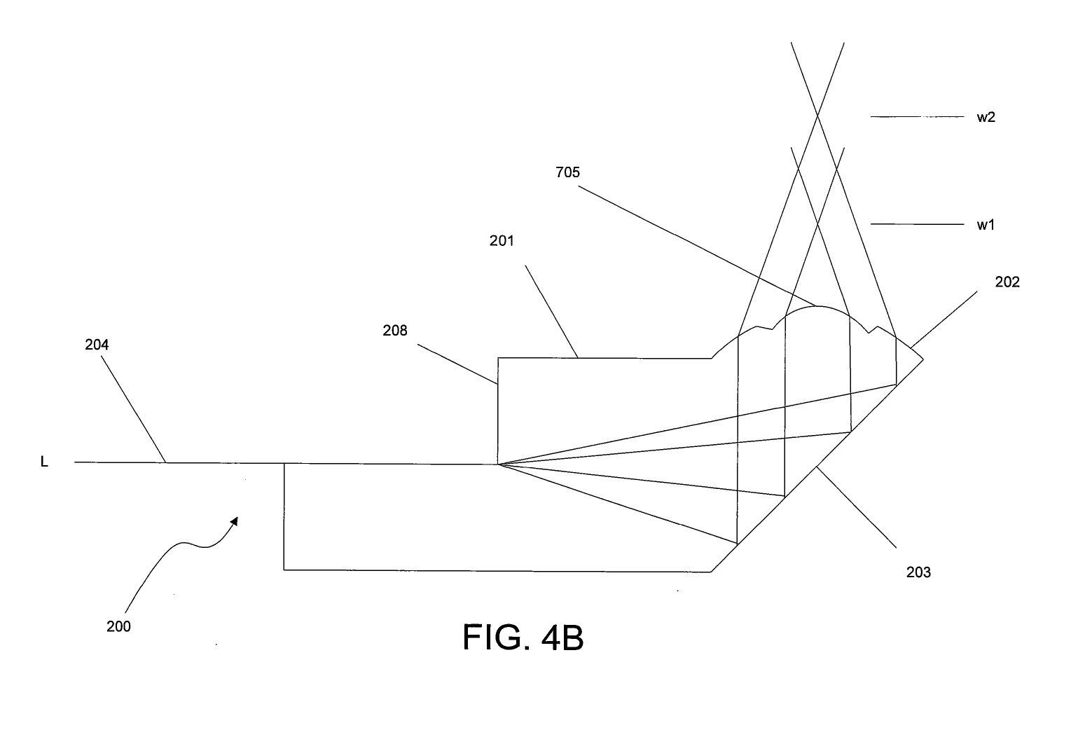

Another design of a low cost extended depth of field optical probe 200 is illustrated in FIG. 4A. Shown in diagram (a) are single mode fiber 204, spacer 201, lens 202 and prism 203. Spacer 201 includes face 208. The core (not shown) of fiber 204 is positioned at the face 208 of spacer 201. Optical probe 200 is illustrated as a molded optical probe as described, for example, in U.S. patent application Ser. No. 14/011,191, filed Aug. 27, 2013, entitled A LOW COST MOLDED OPTICAL PROBE WITH ASTIGMATIC CORRECTION, FIBER PORT, LOW BACK REFLECTION, AND HIGHLY REPRODUCIBLE IN MANUFACTURING QUANTITIES, and U.S. Provisional Patent Application Ser. No. 61/696,616, filed Sep. 4, 2012, the contents of each of which are incorporated herein by reference.

Also shown is a modified lens portion 205 having a different radius of curvature than lens 202. In the preferred embodiment, the index of refraction of lens 202 is the same as the index of refraction of modified lens portion 205, as they are molded from the same material. This will change the optical parameter for a given portion of the beam, thus providing another design feature that can be changed to arrive at a particular optical prescription. The modified lens portion can be an add-on component, for example a drop of glue. Alternatively, the first lens surface 202 can be flat, concave, or convex and the second surface 205 can be flush, extend outward or sunk into the concave lens 202. Each configuration allows for the individual control of the waist size, waist location, and optical path length of each waist. The shapes of the two lenses can be altered and their respective positions to one another can also be altered thus producing different diameters of the probe and different waist patterns; having two surfaces creates two waists. In addition, these physical geometries can also include lens and lens portions having spherical, cylindrical, toroidal, or polynomial shapes; other shapes are contemplated. Further, the physical geometry of the surface of the probe that is selected (e.g. cylindrical) does not need to be the same as the physical geometry of the modified lens portion that is selected (e.g. spherical).

Although shown having only one modified lens portion 205, multiple step modified lens portions can be included. On each step, the radius of curvature is changed to yield multiple waists, one for each step.

FIG. 4B illustrates a variation of the probe design of FIG. 4A. Shown are single mode fiber 204, spacer 201, lens 202 and prism 203. Spacer 201 includes face 208. The core (not shown) of fiber 204 is positioned at the face 208 of spacer 201. Also shown is a modified lens portion 705 having a different radius of curvature than lens 202. In the preferred embodiment, the index of refraction of lens 202 is the same as the index of refraction of modified lens portion 205, as they are molded from the same material. This will change the optical parameter for a given portion of the beam, thus providing another design feature that can be changed to arrive at a particular optical prescription. The modified lens portion 705 is molded at different curvatures than the curvature of lens 202. Each configuration allows for the individual control of the waist size, waist location, and optical path length of each waist. The shapes of the two lenses can be altered and their respective positions to one another can also be altered thus producing different diameters of the probe and different waist patterns; having two surfaces two multiple waists.

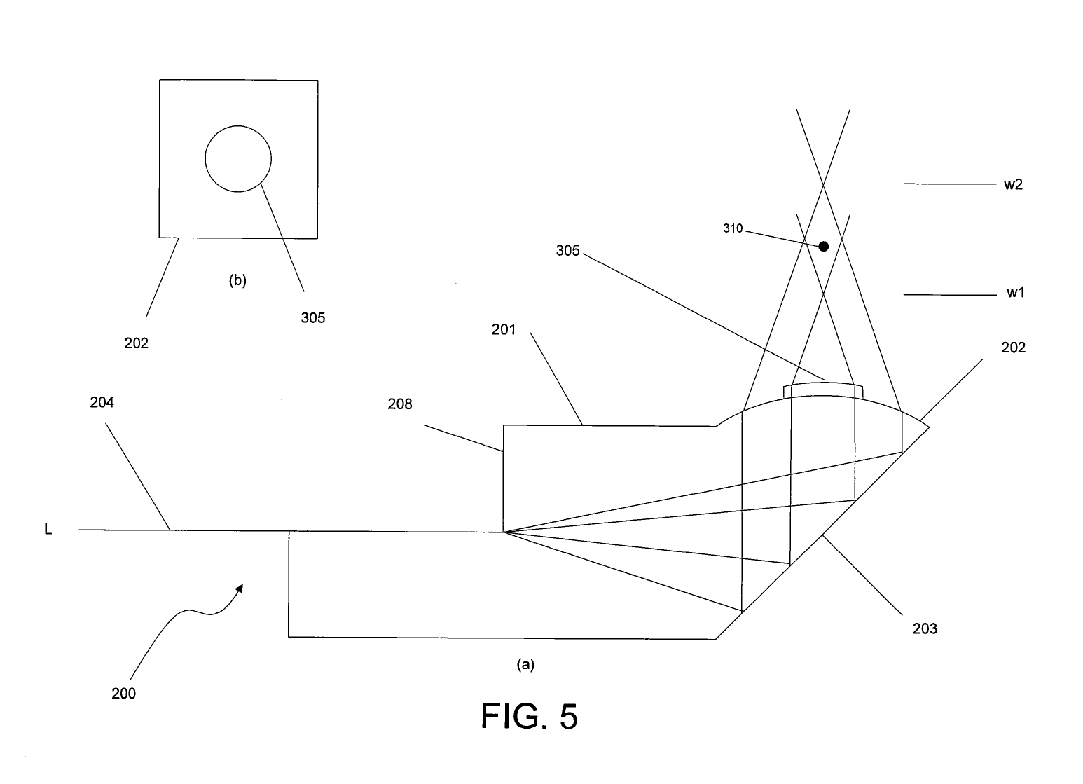

An alternative design of the low cost extended depth of field optical probe is illustrated in FIG. 5. Shown in diagram (a) of FIG. 5 are single mode fiber 204, spacer 201, lens 202 and prism 203. A modified lens portion 305 has the same radius of curvature of lens 202. The path length of the modified lens portion 305 is greater than the path length of lens 202. In the preferred embodiment, the index of refraction of lens 202 is the same as the index of refraction of modified lens portion 305, as they are molded from the same material. Diagram (b) illustrates a top-down view of lens 202 and modified lens 305. As described above, different shaped lenses can be used to produce a particular prescription of waists. The first lens surface 202 can be flat, concave, or convex, and the second surface 305 will match the curvature of first lens surface 202 but extend outward. For example, the lens 202 and the modified lens 305 can both be convex, concave or flat and both have the same radius of curvature.

Image point 310 is also shown in FIG. 5. The optical path length position of image point 310 can be adjusted by changing the offset height from the primary lens 202 compared to the height of lens 305. The optical path length offset position of image point 310 is determined by:

(n2−n1)*length (1)

where n1 is the index of refraction of air, n2 is the index of refraction of the lens material, and length is the thickness of lens 305. The increased or decreased height of lens 305 will change the distance between the fiber (object) and the lens. The waist location (image location) can be approximated using the lens-maker's equation with a paraxial ray approximation where z is the lens to object distance, z′ is the lens to image distance, and f is the focal length of the lens. If the object is on the left side of the lens and the image is on the right side of the lens, z will be negative and z′ will be positive. The equation is as follows:

1/z′=1/z+1/f (2)

For example, if lens 305 is 1 mm in thickness and has an index of refraction n2 of 1.5, and assuming the index of refraction of air n1 of 1, then an optical path length offset of 0.5 mm relative to point 310. This means the OCT system with no correction will interpret the same point as 0.5 mm away unless otherwise calibrated. With a known separation, the imaging system can then interpret the locations of the actual beams. It is noted that this theory is applicable to the various embodiments disclosed herein.

Although shown having only one modified lens 305, multiple step modified lenses can be included. On each step, the radius of curvature is changed to yield multiple waists, one for each step.

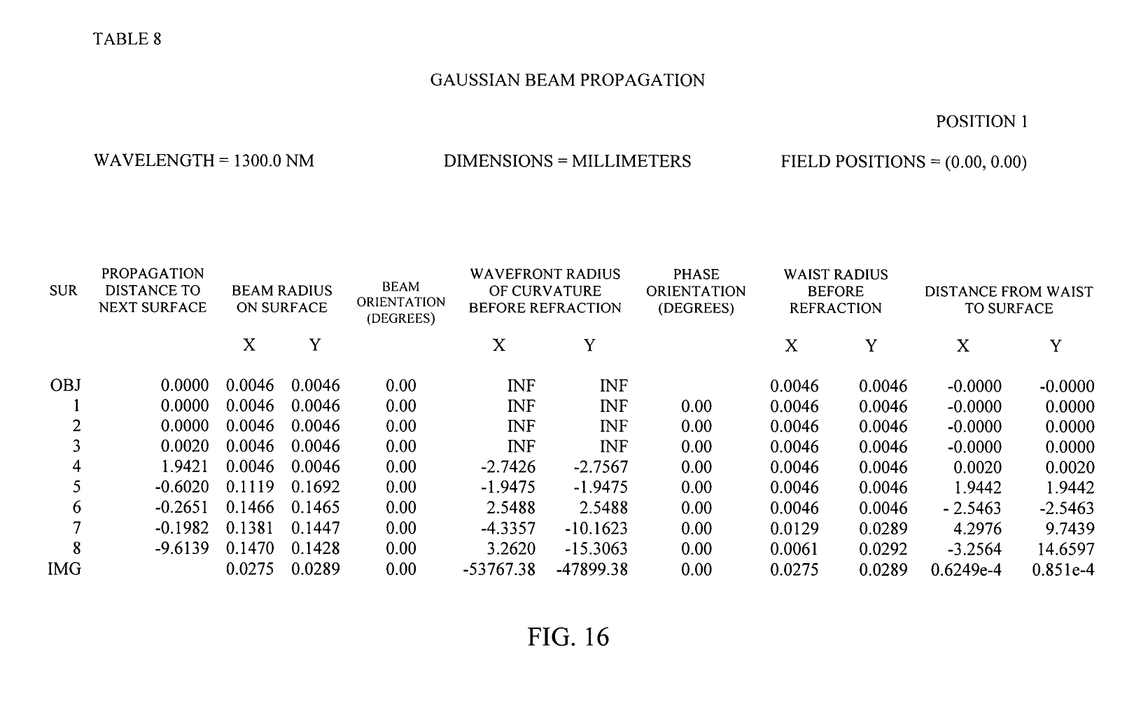

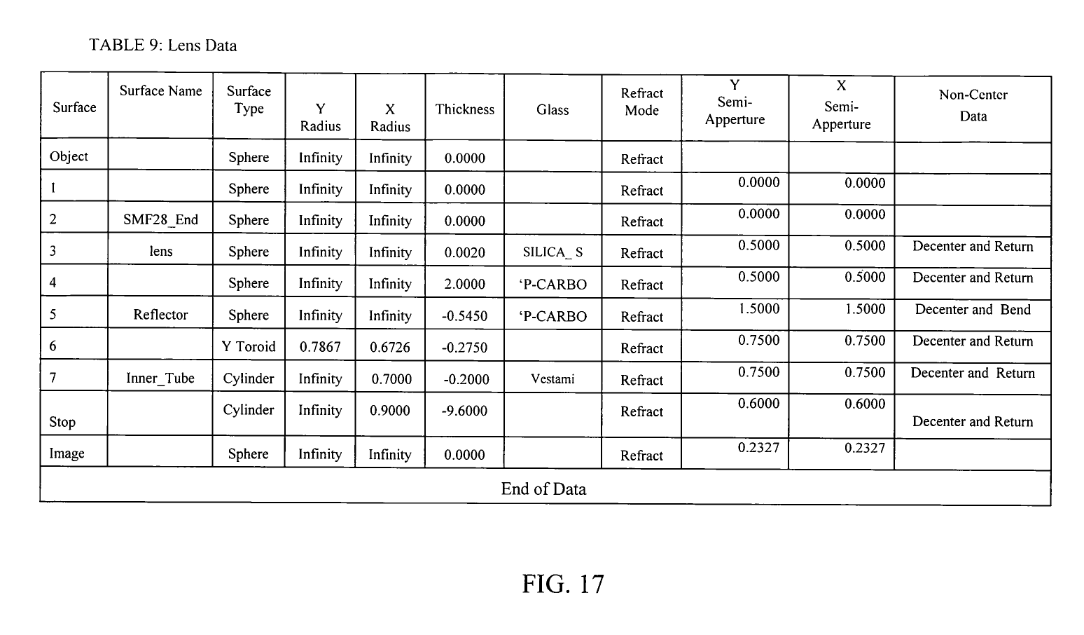

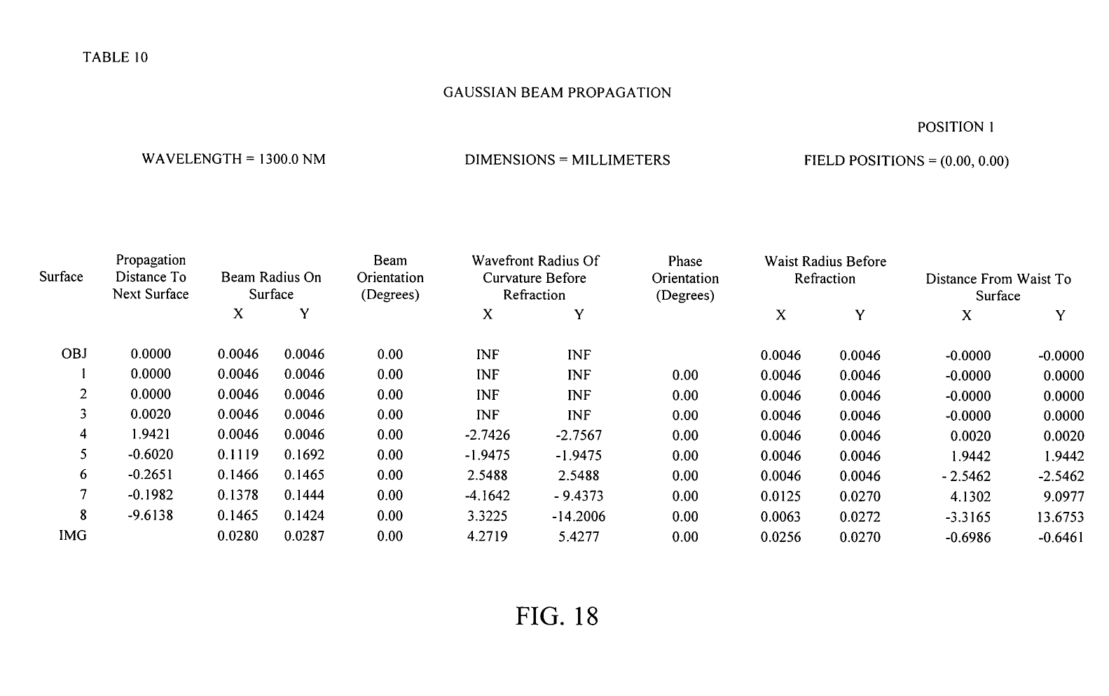

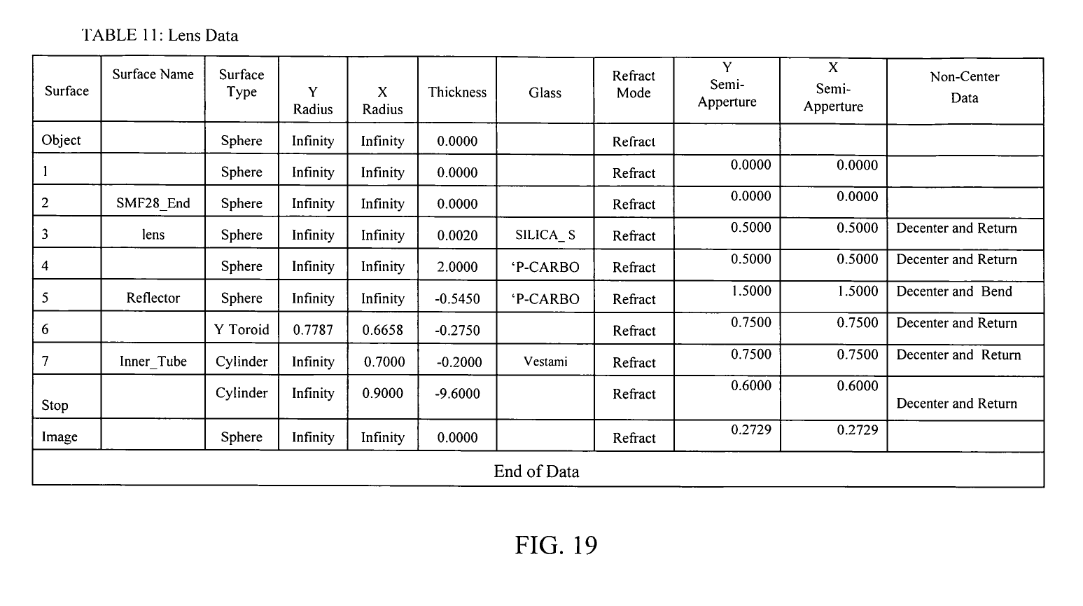

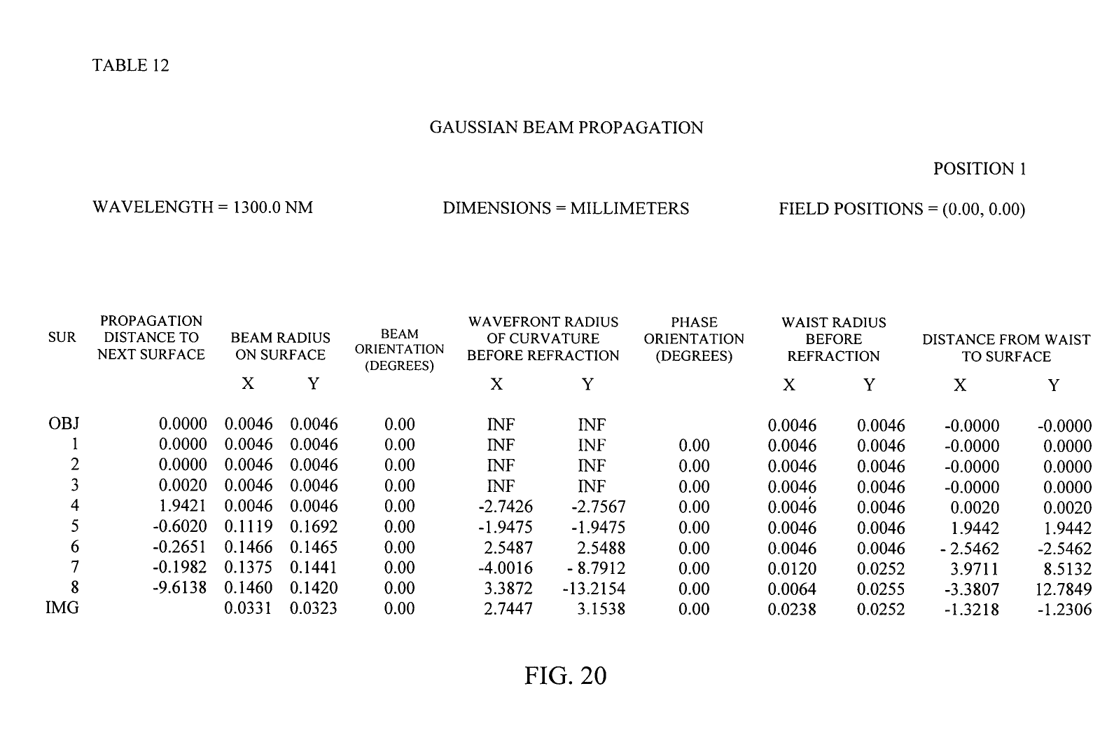

Tables 7-12 submitted as FIGS. 15-20 illustrate varying design data and parameters for the optical probe of Design 2. The experimental data shown in Tables 7-12 utilized a polycarb single surface 20 mm lens. Tables 7 and 8 contain the experimental data of a lens having an X and Y radius of curvature of 0.7946 mm and 0.6794 mm respectively and producing a beam with the following characteristics: beam waist position of 10.62 mm; working distance in X and Y axis with waist size of 27.5 μm and 28.9 μm 1/ê2 radius respectively.

The experimental data of Tables 9-10 demonstrates the effects that a 1% change in the radius of curvature has on the beam radius and working distance. A 1% change in radius of curvature for this specific example yields a change of beam waist position of −0.6986 mm and −0.6461 mm with a change in waist sizes of −1.9 μm and −1.9 μm 1/ê2 radius in the X and Y axis respectively.

The experimental data of Tables 11-12 demonstrates the effects that a 2% change in the radius of curvature has on the beam radius and working distance. A 2% change in radius of curvature for this specific example yields a change of beam waist position of −1.3218 mm and −1.2306 mm with a change in waist sizes of −3.7 μm and −3.7 μm 1/ê2 radius in the X and Y axis respectively.

As is illustrated by the experimental data, the working distances and the positions of the waists can be adjusted by adjusting the indexes of refraction as well as the radius of curvature of the lens. From this data, it can be seen the change in the radius of curvature is reasonable for a machine shop to control. The change is significant enough to machine the differences accurately, while needing to modify the shape excessively making the geometry difficult to create.

Design 3

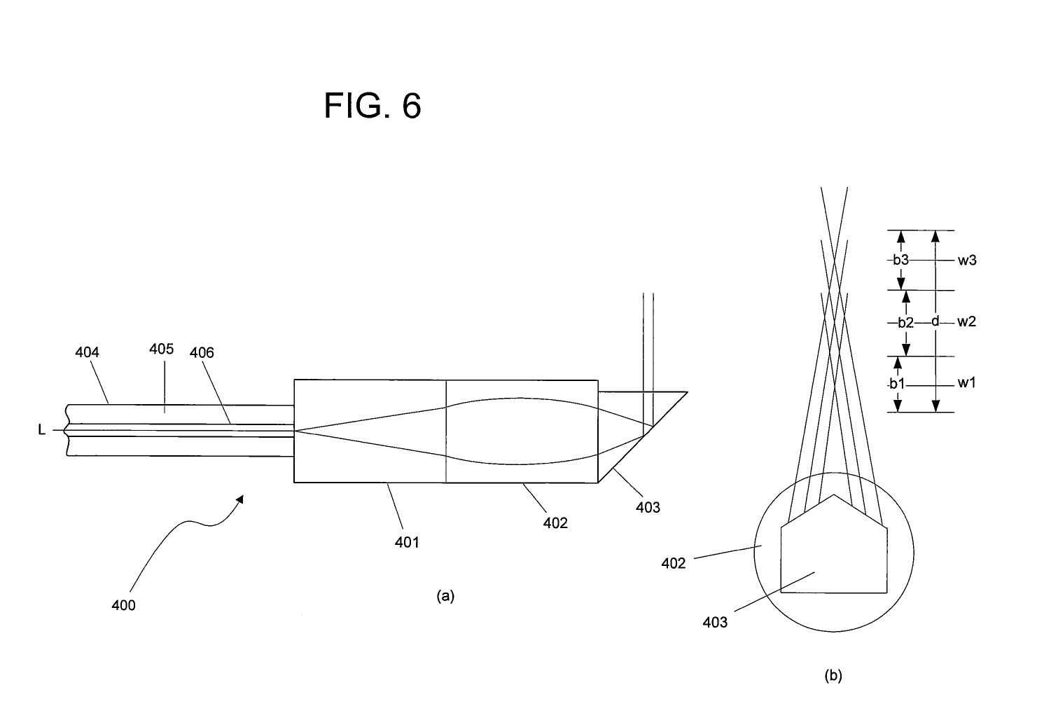

Another design of a low cost extended depth of field optical probe 400 is illustrated in FIG. 6. Shown in diagram (a) are single mode fiber 404 having cladding 405 and core 406, spacer 401, lens 402 and prism 403. Diagram (b) illustrates a front view of lens 402 and prism 403. Normally, on a GRIN lens optical probe there is a cylindrical curvature on the exit side of the right angle prism which creates a single waist. In accordance with the present disclosure and as illustrated in diagram (b), prism 403 is reshaped from a standard cylindrical surface to a “roof” prism. This redesign creates an extended field of view optical probe. This transition into the “roof” prism 403 is relatively easy to manufacture and creates an axicon effect extending the depth of field. This “roof” design, as opposed to the full axicon lens, only provides the extended field of depth properties in one plane as shown between diagrams (a) and (b) of FIG. 6.

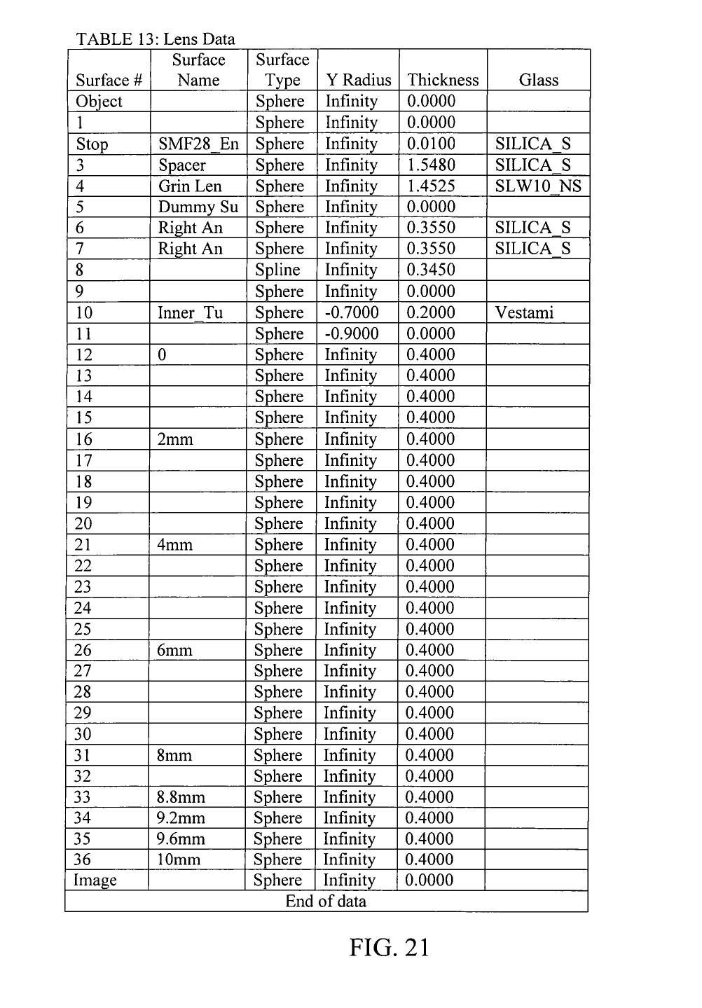

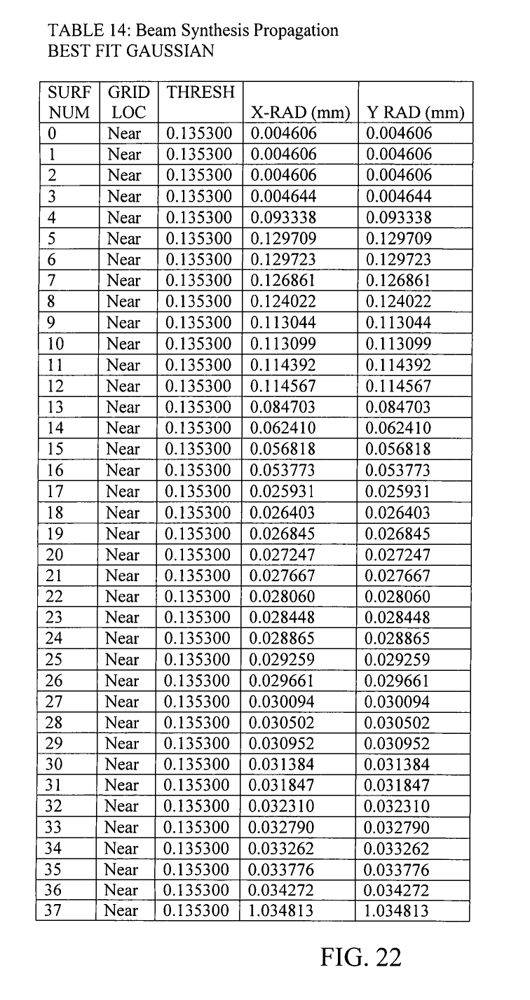

Tables 13-14 submitted as FIGS. 21-22 illustrate varying design data and parameters for the optical probe of Design 3. The experimental data shown in Tables 13-14 utilized a 20 mm GRIN lens subjected to a forward looking axicon test. For demonstration of principle purposes, the example provided is forward looking to reduce the complexity of verifying image planes, and locations are perpendicular in calculations. An angle can easily be added to make the probe side firing while keeping all of the optical properties shown. The prism normally has a cylindrical curvature to correct for the negative power added by the inner lumen. A cylindrical curvature has a single power over the entire lens. An axicon on the other hand, has a varying amount of power as a function of field. Since the GRIN lens contains the primary focusing mechanism to push the working distance out, an axicon may be used to continuously vary the power of the correction optic. FIG. 22 illustrates the design and FIG. 23 illustrates the results. The results are beam propagation values where a best fit Gaussian is placed over an intensity plot and then the values are taken at 1/ê2 radius. As in FIG. 23, from surfaces 17 to 36, a distance of 7.6 mm, the smallest and largest beam size is 25.9 μm and 34.3 μm respectively. This illustrates the resolution will be held consistent over this 7.6 mm range where a single 33 μm 1/ê2 beam waist radius would have an imaging distance of 5.4 mm and beam sizes ranging from 46.7 μm on the edges to 33 μm 1/ê2 radius in the center of the depth of focus. As is illustrated by the experimental data, the working distances and the positions of the waists can be adjusted by adjusting the compensation optic to varying in power as a function of field with an optic such as an axicon.

Design 4

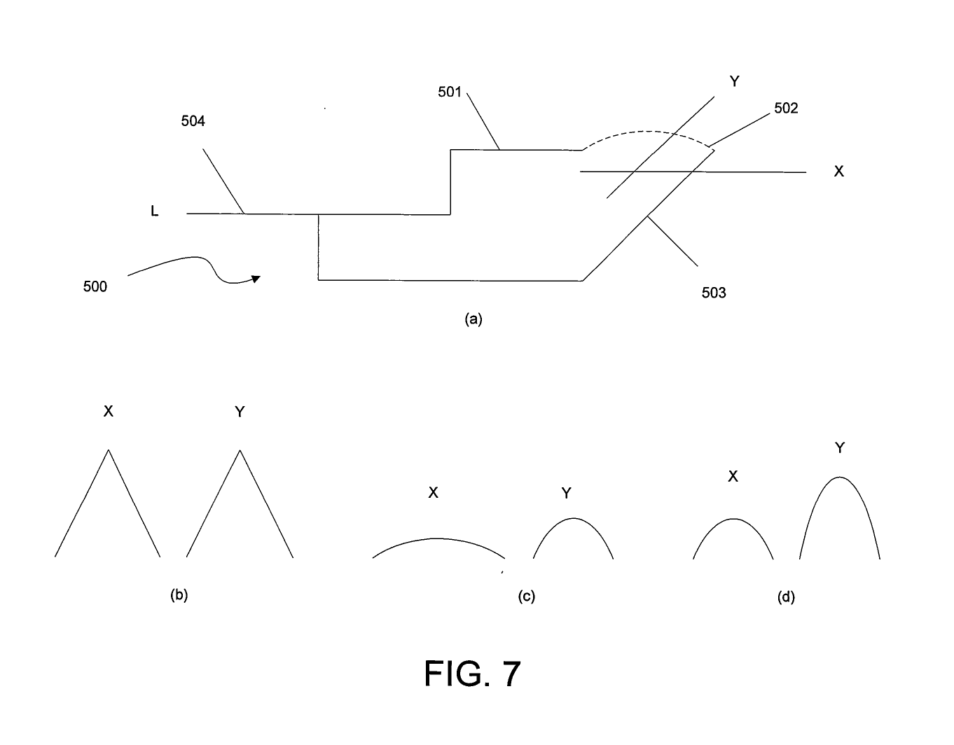

In this design, illustrated in FIG. 7, the optical probe 500 shown in diagram (a) includes spacer 501, lens 502, prism 503 and optical fiber 504. The design incorporates differing lens 502 surface shapes into a molded optical probe. One example of a molded optical probe is described in U.S. patent application Ser. No. 14/011,191. For example, a “roof” shape or an axicon shape lens 502 can produce multiple waists that extend the depth of field for the probe.

Various lens shapes are shown in diagrams (b)-(d). A lens 502 shape shown in diagram (b) produces multiple waists and a shorter working distance. By varying the angles of the surfaces of lens 502 in the X axis and Y axis, the position of the waists and working distance can be adjusted. A lens 502 shape shown in diagram (c) produces a single waist at a variable working distance depending on the curvatures. A lens 502 shape shown in diagram (d) is a hybrid of the lens shapes 502 shown in diagrams (b) and (c) and produces multiple waists and an extended working distance. These additional waist patterns provide for different prescriptions.

Design 5

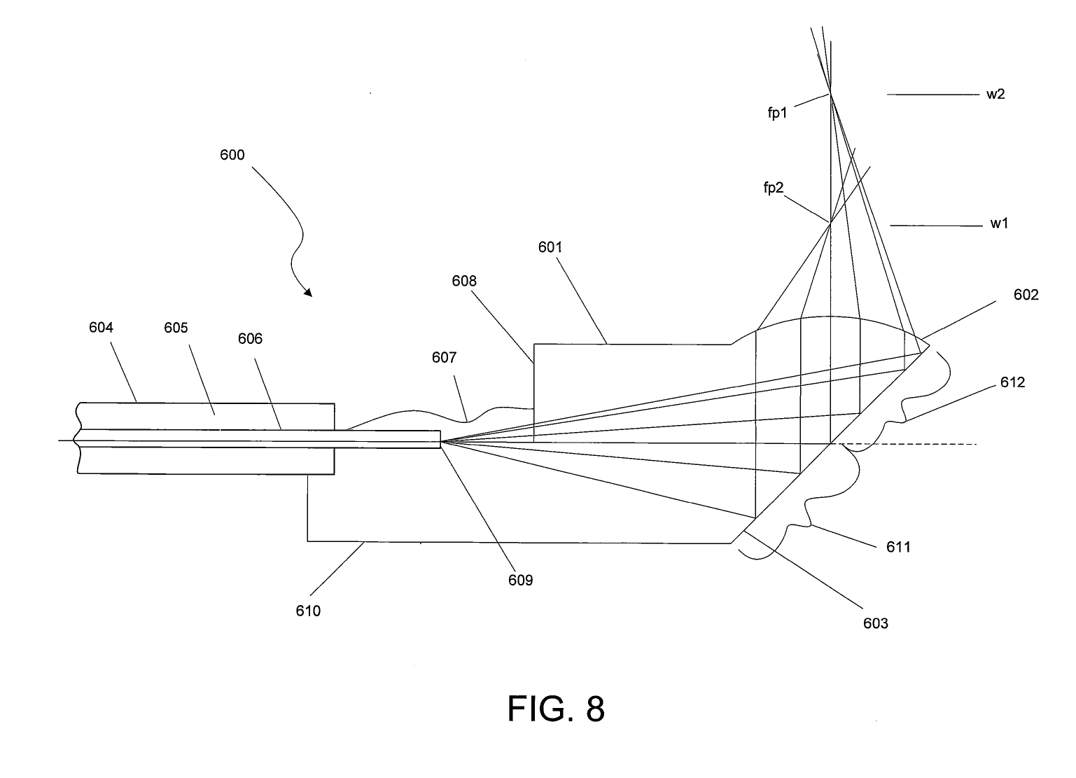

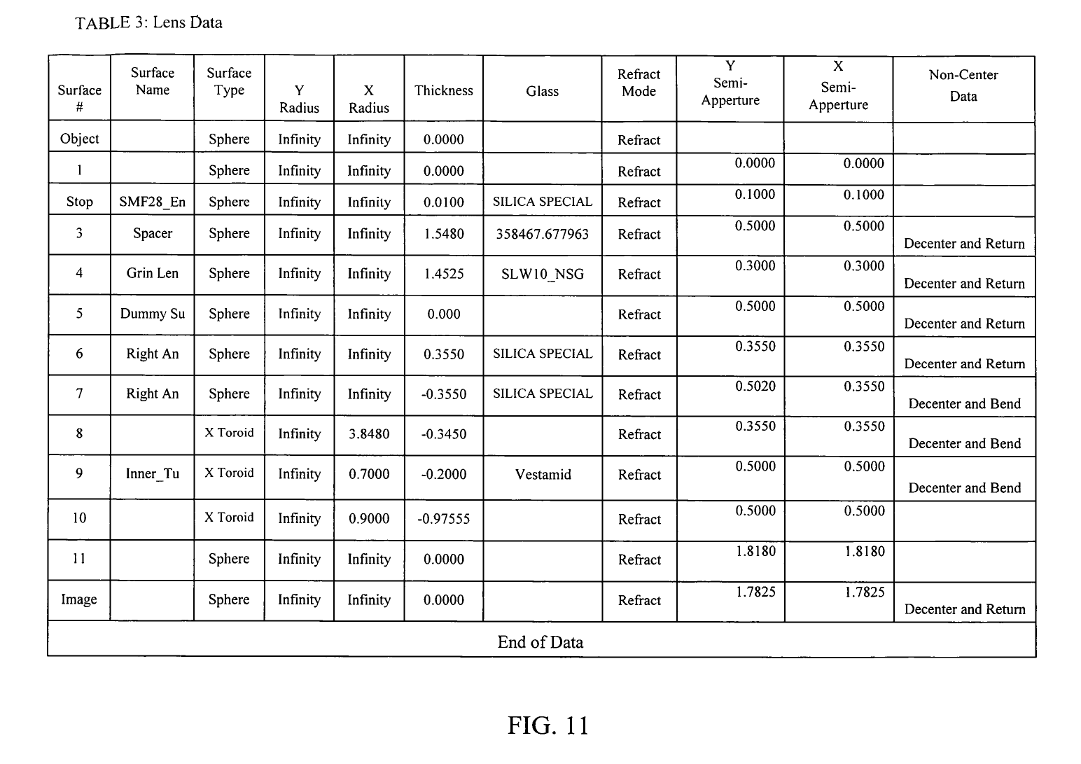

Similarly to other designs, this design is applicable to a molded optical probe, for example as described in U.S. patent application Ser. No. 14/011,191. Shown in FIG. 8 is optical probe 600. Optical probe 600 includes spacer 601, lens 602, prism 603, and fiber optic portion 610. Spacer 601 includes exposed face 608. Fitted within a groove (not shown) in fiber optic portion 610 is fiber optic 604. Groove can be stepped to accommodate both cladding 605 and core 606. Core 606 extends to distal end 609. Optical glue or epoxy 607 is used to secure core 606 to probe 600 within the groove and the epoxy 607 is only placed on the top approximate ½ of the core 606. This allows for any rays below the ½ mark to not pass through the glue and any rays above the ½ mark to pass through the glue creating different focal points and waists depending on whether the rays passed through the glue or not. The index of refraction can be varied by using different glues and/or by varying the placement of the glue. A space is defined between distal end 609 of core 606 and face 608. The lens 602 prescription remains constant and by changing the distance between distal end 609 of core 606 and face 608 (i.e. changing the path length) the optical probe 600 produces multiple waists. Different waist positions and depth of fields can be produced by adjusting the distance between distal end 609 of core 606 and face 608. Rays 611 will have the same focal point fp1 and rays 612 will have the same focal point fp2. In addition, the face 608 can be modified to have a step configuration, thus producing additional distinct waists at the output.

By changing the index of refraction between the core 606, the glue 607 and the molded material of the probe 600, the depth of field can be changed in a manner similar to that described with respect to Design 1. Multiple waists can form a continuous stream of waists as illustrated or waists can be positioned in an unaligned manner by modifying the index of refraction. The distances the waist(s) are formed from the surface of the exposed side of lens 602 can also be changed by modifying the index of refraction.

The optical probe designs disclosed herein provide an extended depth of field for OCT imaging. In prior art designs the power of the imaging was reduced thus producing an overall lower SNR. In the present designs, the power can be reduced to almost ½ of the original power with only a 3-db loss in SNR.

Also, in an imaging system using a 25 mm balloon, the presently disclosed designs can produce a waist 12.75 mm into the tissue producing a depth of field of a full 15 mm. By modifying the parameters of the disclosed optical probes, the depth of field can be varied between 10 mm to 20 mm. These results can be produced while maintaining acceptable transverse resolution over the entire range.

A method for creating multiple waists having specific waist sizes and locations will now be described.

The optical path length is modified and controlled relative to each beam waist and how the OCT console perceives an image by using different materials with varying index of refraction and/or varying the physical geometry of the probe itself. The multiple waists are created by changing the power of the lens, divergence of the beam, and/or optical path length between the fiber or fibers to the lens as a function of field and/or section of the aperture. The multiple beam waists may contain two or more waists.

In order to create multiple waists from one or more lasers with each waist having a specific waist size and location, the optical path length of beam waists created is controlled to be matching or separated by a specific distance relative to the OCT image and console. By varying the optical path lengths, the number of waists as well as their positions and sizes can be varied. These variations can be produced by adjusting one or more indexes of refraction of adjacent optical elements. By fine tuning the indexes, the multiple waists with varying positions and sizes can be produced while generating an imaging depth of field that greatly exceeds current technology.

Also, these variations can be produced by modifying the physical geometry of the lens itself. Providing a lens with multiple and differing curvatures produces multiple waists, again having differing positions and sizes. By fine tuning the different curvatures, the multiple waists with varying positions and sizes can be produced while generating an imaging depth of field that greatly exceeds current technology. Combinations of the two methods are also contemplated.

The extended depth of field optical probe according to the present disclosure provides a longer depth of field when the same lateral resolution is maintained, provides a higher resolution when the same depth of field is obtained relative to a single waist being created, and provides a longer depth of field with higher resolution with the correct prescription compared to a single beam waist.

The components of the optical probes described herein can be fabricated from materials suitable for medical applications, including glasses, plastics, polished optics, metals, synthetic polymers and ceramics, glues, and/or their composites, depending on the particular application. For example, the components of the system, individually or collectively, can be fabricated from materials such as polycarbonates such as Lexan 1130, Lexan HPS2, Lexan HPS6, Makrolon 3158, or Makrolon 2458, such as polyetherimides such as Ultem 1010, and/or such as polyethersulfones such as RTP 1400 and cyclic olefins.

Various components of the system may be fabricated from material composites, including the above materials, to achieve various desired characteristics such as strength, rigidity, elasticity, flexibility, compliance, biomechanical performance, durability, sterilization, and radiolucency or imaging preference. The components of the system, individually or collectively, may also be fabricated from a heterogeneous material such as a combination of two or more of the above-described materials.

The present disclosure has been described herein in connection with an optical imaging system including an OCT probe. Other applications are contemplated. In addition, although embodiments are described herein using a prism to deflect the light, optical probes without prisms are also contemplated. In this description a Bessel beam is also defined as a form of multiple waists.

Where this application has listed the steps of a method or procedure in a specific order, it may be possible, or even expedient in certain circumstances, to change the order in which some steps are performed, and it is intended that the particular steps of the method or procedure claim set forth herebelow not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. An extended depth of field optical probe, comprising:
a lens; and
a spacer positioned adjacent the lens,
wherein the spacer and lens are configured to produce a plurality of waists at a plurality of working distances by varying at least one of an index of refraction of adjacent optical components of the spacer and a physical geometry of a surface of the probe, and
wherein the working distance of a first waist is greater than 0.

2. The extended depth of field optical probe of claim 1, wherein a first waist of the plurality of waists is produced a preset distance from the optics.

3. The extended depth of field optical probe of claim 1, wherein the spacer and lens are configured to produce an imaging depth of field of approximately 10 mm to 20 mm.

4. The extended depth of field optical probe of claim 1, wherein the spacer comprises:
an optical core having a first index of refraction; and
an optical outer portion positioned about the optical core and having a second index of refraction different from the first index of refraction.

5. The extended depth of field optical probe of claim 4, wherein the second index of refraction is greater than the first index of refraction.

6. The extended depth of field optical probe of claim 4, further comprising at least one intermediate portion positioned between the optical core and the optical outer portion, wherein the at least one intermediate portion generates a separate waist at a distinct position and having a distinct path length.

7. The extended depth of field optical probe of claim 1, further comprising a prism positioned adjacent the lens, wherein the surface of the probe is located on the prism.

8. The extended depth of field optical probe of claim 1, wherein the physical geometry of the surface of the probe is modified such that a portion of the surface is extended from the surface of the probe and the extended portion has a physical geometry the same as the physical geometry of the surface of the probe.

9. The extended depth of field optical probe of claim 8, wherein multiple portions of the surface are modified, each modification producing a separate waist at a distinct location and having a distinct path length.

10. The extended depth of field optical probe of claim 1, wherein the physical geometry of the surface of the probe is modified such that a portion of the surface of the probe has a physical geometry different from the physical geometry of the surface of the probe.

11. The extended depth of field optical probe of claim 10, wherein multiple portions of the surface are modified, each modification producing a separate waist at a distinct location and having a distinct optical path length.

12. The extended depth of field optical probe of claim 1, wherein the physical geometry of a surface of the probe comprises a first side and a second side transverse to the first side.

13. An extended depth of field optical probe, comprising:
a mounting portion to mount an optical fiber;
a beam expander positioned in a path of an optical beam of the optical probe configured to expand the optical beam; and
a lens positioned in the path of the optical beam of the optical probe configured to focus the optical beam,
wherein the beam expander is configured to change an optical path length at different portions of the optical beam producing a plurality of waists at a plurality of working distances, and
wherein the working distance of a first waist is greater than 0.

14. The extended depth of field optical probe of claim 13, wherein the beam expander is a spacer positioned before the lens in the path, comprising:
an optical core having a first index of refraction; and
an outer portion positioned about the optical core and having a second index of refraction different from the first index of refraction.

15. The extended depth of field optical probe of claim 13, wherein the beam expander is a modification to a portion of a surface of the probe.

16. The extended depth of field optical probe of claim 15, wherein a physical geometry of the beam expander is the same as a physical geometry of the surface of the probe.

17. The extended depth of field optical probe of claim 15, wherein a physical geometry of the beam expander is different from a physical geometry of the surface of the probe.

18. A method for generating multiple waists and an extended depth of field by an optical probe, comprising the steps of:
modifying at least one portion of a light traveling along a light path to change an optical path length of the modified portion of light and produce a plurality of waists at a plurality of working distances and having distinct optical path lengths,
wherein the working distance of a first waist is greater than 0.

19. The method for generating multiple waists and an extended depth of field by an optical probe of claim 18, wherein the at least one portion of light is modified by modifying a portion of a surface of the probe.

20. The method for generating multiple waists and an extended depth of field by an optical probe of claim 18, wherein the at least one portion of light is modified by a spacer having an optical core and an optical outer portion, the optical core having an index of refraction different from an index of refraction of the optical outer portion.
